(19) United States
(12) Patent Application Publication
(10) Pub. No.: US 2020/0280354 A1
(43) Pub. Date: Sep. 3, 2020

(54) Method and Apparatus for Switching a Transmit Path of a Transceiver Between Three or More Antennas

(71) Applicant: Motorola Mobility LLC, Chicago, IL (US)

(72) Inventors: Jatin Kulkarni, Naperville, IL (US); Robert Trocke, Caledonia, WI (US); Brian Bremer, Arlington Heights, IL (US); Armin Klomsdorf, Chicago, IL (US)

(21) Appl. No.: 16/290,846

(22) Filed: Mar. 1, 2019

(51) Int. Cl. H04B 7/06; H04B 7/0413; H04B 7/08

(52) U.S. Cl. CPC H04B 7/0602; H04B 7/0802; H04B 7/0413

(57) ABSTRACT

The present application provides an antenna switching circuit, a wireless communication device and a method for switching a transmit path of a transceiver between three or more antennas. The antenna switching circuit includes three or more antennas, and a switch coupled to each of the three or more antennas. The antenna switching circuit further includes a controller coupled to the switch, as well as a transceiver, which is coupled to each of the three or more antennas via the switch. Each of the coupled antennas is selectively associated with a different respective receive path of the transceiver, and the transceiver has a transmitter path that can be separately selectively coupled to any one of the three or more antennas via the switch under the control of the controller.

### FIELD OF THE APPLICATION

The present disclosure relates generally to controlling the transmit path of a wireless communication device, and more particularly, to selective coupling of the transceiver to one of multiple antennas in support of the transmission of a wireless radio frequency signal.

### BACKGROUND

Wireless communication devices are continuously integrating new and enhanced features, that leverage an ability to remotely transmit and receive data using wireless communication capabilities. As the features are added and/or enhanced, there often is a need to communicate wirelessly, an ever increasing amount of information/data in order to support the added and/or enhanced features of the device. This need for additional data throughput impacts both the overall operation of the network, as well as the data throughput relative to individual devices operating within the network.

The overall desire for higher data throughput for at least some cellular networks has led to at least some networks implementing support for Multiple Input Multiple Output (MIMO) forms of communication, including for example 4×4 MIMO relative to one or more bands of operation, while simultaneously supporting carrier aggregation. MIMO is a method for expanding the capacity of a radio link using multiple transmit and receive antennas, where multipath propagation properties are used to distinguish between different sets of signaling sent simultaneously over the same radio channel via separate antennas. MIMO is distinct from other throughput enhancement techniques developed to augment the performance of a propagated data signal, such as a beamforming signal processing technique and/or a multiple antenna diversity scheme. Carrier aggregation allows a number of separate carriers to be combined into a single data channel to enhance the data rates and data throughput capacity relative to a particular user.

While many prior communication techniques combined the performance of a pair of antennas in support of a communication connection, a 4×4 MIMO technique expands this requirement for multiple antennas in support of a communication connection even further, so as to include at least four spatially distinct antennas. Such a requirement extends beyond the two spatially distinct antennas that supported prior signal diversity schemes. Correspondingly, some manufacturers have begun to integrate sets of antennas that incorporate individual respective antennas that each reside proximate a separate location around the device. For example, each of the four antennas can each separately reside proximate a corresponding one of the four corners of the device for use in receiving a 4×4 MIMO signal. In at least some instances, the device continues to transmit via a single transmit antenna.

However, it is possible that a particular one of the antennas assigned to transmit a signal can be at least temporarily compromised. For example, depending upon how a user is holding the device, the user's hand could come within proximity of one or more of the antennas. For example, in some instances, such as use in landscape mode, where multiple hands may be holding the device, it is possible for multiple antennas including antennas located at opposite sides of the device to be compromised. This can be particularly problematic, where the antennas are formed as part of an exterior metal housing.

When a user's hand encroaches upon and/or comes into contact with an antenna, for lower frequency signals, the hand can de-tune the antenna. In some of these cases, an antenna tuner can help to alleviate these concerns. However for higher frequency signal bands, the hand can absorb some of the energy, where an antenna tuner may be insufficient to fully recover from the corresponding adverse affects.

The present innovators have recognized that often there is an antenna among the various three or more spatially distinct antennas, that has not been compromised. Correspondingly by switching the transmit function to one of the uncompromised antennas, via a switch coupled to each of the three or more antennas, acceptable signal transmission performance may continue to be possible.

### SUMMARY

The present application provides an antenna switching circuit. The antenna switching circuit includes three or more antennas, and a switch coupled to each of the three or more antennas. The antenna switching circuit further includes a controller coupled to the switch, as well as a transceiver, which is coupled to each of the three or more antennas via the switch. Each of the coupled antennas is selectively associated with a different respective receive path of the transceiver, and the transceiver has a transmitter path that can be separately selectively coupled to any one of the three or more antennas via the switch under the control of the controller.

In at least one embodiment, the antenna switching circuit further includes one or more sensors, which can be used to detect the conditions in which one or more of the three or more antennas are at least temporarily excluded from being coupled to the transmitter path of the transceiver by the controller.

In at least a further embodiment, the controller monitors, on an ongoing basis, the one or more sensors, and adjusts where appropriate an exclusion by the controller of any one of the three or more antennas from being coupled to the transmitter path of the transceiver.

The present application further provides a method for switching a transmit path of a transceiver between three or more antennas. The method includes evaluating signal propagation characteristics for each propagation path respectively associated with conveying a signal between each of the three or more antennas and a separate remote communication partner. A selection is then made by a controller via a switch of a particular one of the three or more antennas to couple to the transmit path of the transceiver.

The present invention still further provides a wireless communication device. The wireless communication device includes an antenna switching circuit having three or more antennas, a switch coupled to each of the three or more antennas, and a controller coupled to the switch. The wireless communication device further includes a transceiver, which is coupled to each of the three or more antennas via the switch, where each of the coupled antennas is selectively associated with a different respective receive path of the transceiver, and wherein the transceiver has a transmitter path that can be separately selectively coupled to any one of the three or more antennas via the switch under the control of the controller.

These and other features, and advantages of the present disclosure are evident from the following description of one or more preferred embodiments, with reference to the accompanying drawings.

### BRIEF DESCRIPTION OF THE DRAWINGS

FIG. 1 is a block diagram of an exemplary network environment;

FIG. 2 is a front view of an exemplary user equipment in the form of a wireless communication device, such as a radio frequency radio telephone;

FIG. 3 is an example of a user holding an exemplary device in portrait mode;

FIG. 4 is an example of a user holding an exemplary device in landscape mode;

FIG. 5 is a block diagram of an exemplary wireless communication device;

FIG. 6 is a block diagram of a radio frequency front end circuit for coupling a transceiver having a transmit line and one or more receive lines to a plurality of antennas; and

FIG. 7 is a flow diagram of a method for switching a transmit path of a transceiver between three or more antennas.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification and is not intended to limit the invention to the specific embodiments illustrated. One skilled in the art will hopefully appreciate that the elements in the drawings are illustrated for simplicity and clarity and have not necessarily been drawn to scale. For example, the dimensions of some of the elements in the drawings may be exaggerated relative to other elements with the intent to help improve understanding of the aspects of the embodiments being illustrated and described.

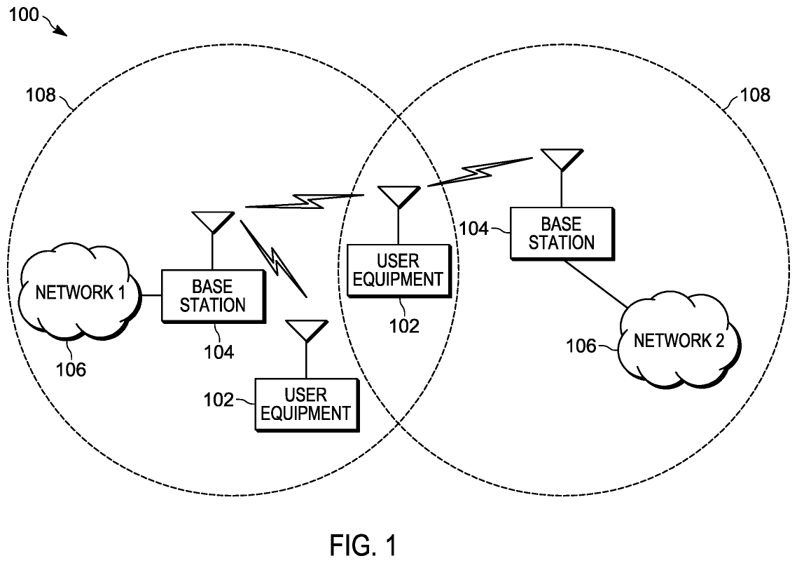

FIG. 1 illustrates a block diagram of an exemplary network environment 100. The exemplary network environment 100 can include one or more wireless communication devices, such as user equipment 102, which might communicate directly with one another, or via one or more networks, each having an associated network infrastructure. For example, the network infrastructure can include one or more base stations 104, which in turn are coupled to other network elements, which correspond to one or more networks, and which are generally represented as clouds labeled network 106. The various base stations 104 can be associated with the same network or can be separately associated with different networks.

A base station 104 will generally have an expected associated area 108 of coverage, which defines the area over which wireless radio frequency signaling from the base station can generally reach. While the strength of wireless radio frequency signaling is generally affected by the range of transmission, within an expected area of coverage, terrain and/or other physical elements can impact the ability of the signaling to be perceived at particular locations within the expected area 108 of coverage. Depending upon the reception capabilities of the user equipment 102, the current signal strength of the signal being transmitted at a particular location will affect whether a particular user equipment 102 can send or receive data with a particular base station 104. As such, some networks 106 will make use of multiple geographically spaced apart base stations 104, to provide communication capabilities across a larger geographical area.

It is further possible that different base stations 104 can be more directly associated with different networks 106, which may interact with one another at different parts of the respective networks. The network(s) 106 can include any type of network that is capable of conveying signals between different associated elements of the network including the one or more user equipment 102.

In some instances, the user equipment 102 is generally a wireless communication device that could take the form of a radio frequency cellular telephone. However, the user equipment 102 could also take the form of other types of devices that could support wireless communication capabilities. For example, the different potential types of user equipment can include a tablet, a laptop computer, a desktop computer, a netbook, a cordless telephone, a selective call receiver, a gaming device, a personal digital assistant, as well as any other type of wireless communication device that might be used to support wireless forms of communication.

The various networks 106, base stations 104 and user equipment 102 could be associated with one or more different communication standards. A few examples of different communication standards that a particular network 106 could support include Global System for Mobile Communications (GSM) Code Division Multiple Access (CDMA), Orthogonal Frequency Division Multiple Access (OFDMA), Long Term Evolution (LTE), New Radio Access Technology (NR), Global Positioning System (GPS), Wi-Fi (IEEE 802.11), as well as various other communication standards. It is possible that each network and/or associated element could support one or more different communication standards. It is also possible that different networks 106 can support one or more of the same standards. In addition, the wireless communication devices 102, base stations 104 and networks 106 may utilize a number of additional various forms of communication and communication techniques including beamforming, signal diversity, and simultaneous voice and data that concurrently enables the use of simultaneous signal propagation.

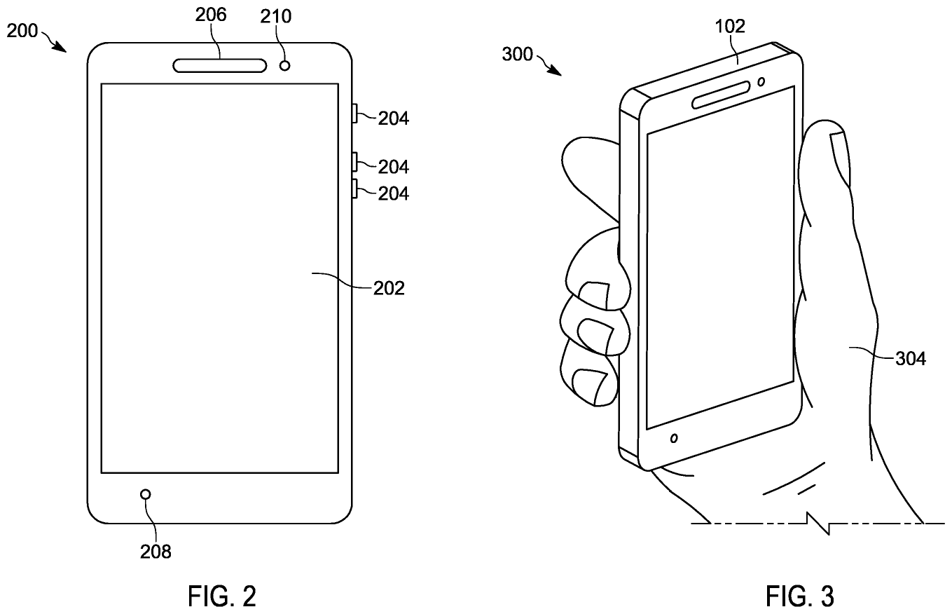

FIG. 2 illustrates a front view 200 of an exemplary user equipment 102 in the form of a wireless communication device, such as a radio frequency radio telephone. In the illustrated embodiment, the radio frequency cellular telephone includes a display 202 which covers a large portion of the front facing. In at least some instances, the display can incorporate a touch sensitive matrix, that can help facilitate the detection of one or more user inputs relative to at least some portions of the display, including an interaction with visual elements being presented to the user via the display 202. In some instances, the visual elements could include an object with which the user can interact. In other instances, the visual elements can form part of a visual representation of a keyboard including one or more virtual keys and/or one or more buttons with which the user can interact and/or select for a simulated actuation. In addition to one or more virtual user actuatable buttons or keys, the device can include one or more physical user actuatable buttons 204. In the particular embodiment illustrated, the device has three such buttons located along the right side of the device.

The exemplary electronic device, illustrated in FIG. 2, additionally includes a speaker 206 and a microphone 208 in support of voice communications. The speaker 206 may additionally support the reproduction of an audio signal, which could be a stand-alone signal, such as for use in the playing of music, or can be part of a multimedia presentation, such as for use in the playing of a movie, which might have at least an audio as well as a visual component. The speaker 206 may also include the capability to also produce a vibratory effect. However, in some instances, the purposeful production of vibrational effects may be associated with a separate element, not shown, which is internal to the device. Generally, the speaker 206 is located toward the top of the device, which corresponds to an orientation consistent with the respective portion of the device facing in an upward direction during usage in a portrait orientation in support of a voice communication. In such an instance, the speaker 206 might be intended to align with the ear of the user, and the microphone 208 might be intended to align with the mouth of the user. Also located near the top of the device, in the illustrated embodiment, is a front facing camera 210. The wireless communication device will also generally include one or more radio frequency transceivers, as well as associated transmit and receive circuitry, including one or more antennas that may be positioned internally relative to the device. In some instances, some or all of the antenna elements may also and/or alternatively be incorporated as part of the housing of the device.

FIG. 3 illustrates an exemplary perspective view 300 of a user holding an exemplary device 102 in a portrait use mode or orientation. More specifically, the exemplary device 102 is being held by the hand 304 of a user. Depending upon their location, relative to the device 102, the hand may come into contact and/or proximity to at least some of one or more antennas. As the hand 304 or other element approaches an antenna element, the hand 304 or other element may have an adverse effect on the ability of the antenna to receive or radiate energy, as intended. In some cases, the element coming into contact or proximity with an antenna can cause a detuning of the same. In other instances, the element coming into contact or proximity with an antenna can block or absorb nearby electromagnetic energy being produced by the antenna, and/or intended to be received via the antenna. In a portrait orientation, the device 102 can be more readily brought into proximity of the mouth and ear of the user, so as to more readily facilitate the receipt and conveyance of an audio signal, relative to a microphone and a speaker. However, in turn, this results in the head of the user being additionally brought into relative proximity to the device 102, and potentially one or more of the antennas.

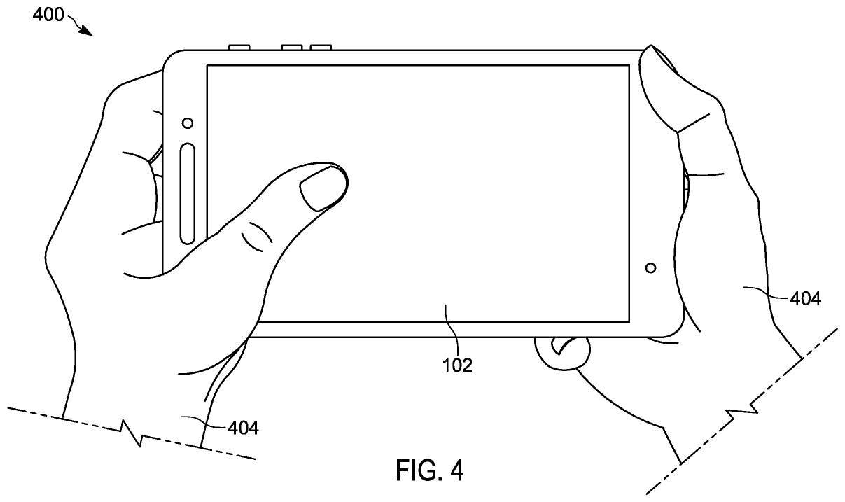

A user, however, can interact with a communication device 102 in multiple different ways. For example, a device 102 could be alternatively tilted and held using two hands 404, which could change the portions of the device with which a user's hand 404 might encroach. FIG. 4 illustrates an alternative examplary perspective view 400 of a user holding an exemplary device 102 in a landscape use mode or orientation.

In at least some instances, various antennas can be positioned so as to correspond with different spatially distinct locations around the device. In some of these instances, various antennas can be respectively located proximate different corners of a device. Depending upon how the device is being held, one or more of the antennas may come into proximity to one of the hands of the user.

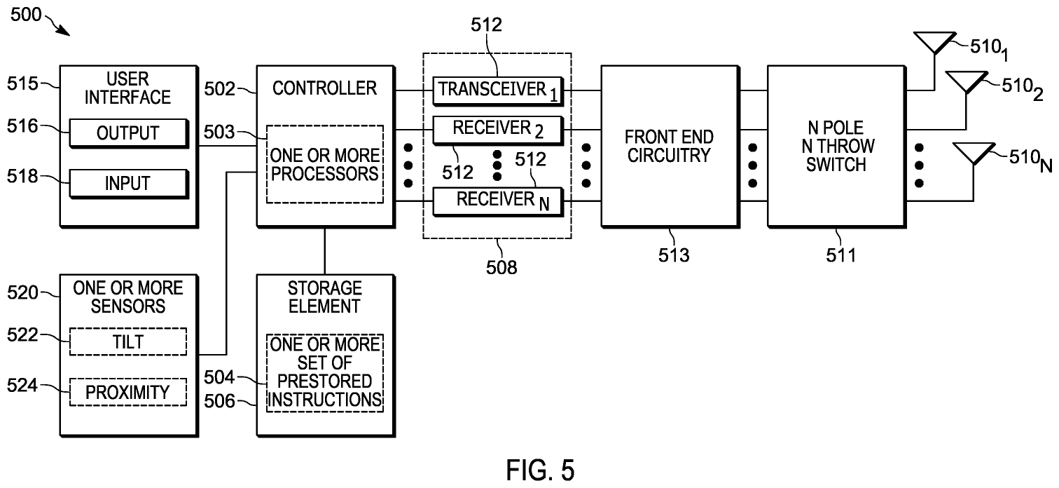

FIG. 5 illustrates a block diagram 500 of an exemplary wireless communication device, in accordance with at least one embodiment. In the illustrated embodiment, the wireless communication device includes a controller 502, which is adapted for managing at least some of the operation of the device. In some embodiments, the controller 502 could be implemented in the form of one or more processors 503, which are adapted to execute one or more sets of pre-stored instructions 504, which may be used to form or implement the operation of at least part of one or more controller modules including those used to manage wireless communication and/or the coupling of wireless communication signals to one or more antennas. The one or more sets of pre-stored instructions 504 may be stored in a storage element 506, which while shown as being separate from and coupled to the controller 502, may additionally or alternatively include some data storage capability for storing at least some of the prestored instructions for use with the controller 502, that is integrated as part of the controller 502.

The storage element 506 could include one or more forms of volatile and/or non-volatile memory, including conventional ROM, EPROM, RAM, or EEPROM. The possible additional data storage capabilities may also include one or more forms of auxiliary storage, which is either fixed or removable, such as a hard drive, a floppy drive, or a memory card or stick. One skilled in the art will still further appreciate that still other further forms of storage elements could be used without departing from the teachings of the present disclosure. In the same or other instances, the controller 502 may additionally or alternatively incorporate state machines and/or logic circuitry, which can be used to implement at least partially, some of the modules and/or functionality associated with the controller 502 including all or portions of the claimed methods.

In the illustrated embodiment, the device further includes a transceiver 508, which is coupled to the controller 502 and which serves to manage the external communication of data including their wireless communication using one or more forms of communications. In such an instance, the transceiver 508 will generally be coupled to one or more antennas 510, via which the wireless communication signals will be radiated and received. For example, the transceiver 508 might include one or more transceiver, transmitter, and/or receiver sub-elements 512 for supporting wireless communications with various networks. Transceivers, receivers and/or transmitters for other forms of communication are additionally and/or alternatively possible. In the present instance, the transceiver 508 is coupled to the one or more antennas 510 via front end circuitry 513 and an N-pole, N-throw switch 511, which can help to facilitate the transceiver 508, and the various transmit and receive paths supported within the transceiver 508 interacting with various respective ones of the one or more antennas 510.

More specifically, the front end circuitry 513 and N-pole, N-throw switch 511 are intended to allow one or more transceiver ports to be selectively coupled to one or more ports associated with the various antenna elements. Front end circuitry can often include various sub-elements, such as power amplifiers, filters, diplexers, duplexers and switches, which help to facilitate the coupling of a produced signal to an antenna. The front end circuitry 513 can further include impedance matching elements, antenna tuners, and/or additional signal amplifiers, so as to more effectively manage the conveyance of signals between the transceivers and the antenna elements.

In the illustrated embodiment, the device can additionally include user interface circuitry 515, some of which can be associated with producing an output 516 to be perceived by the user, and some of which can be associated with detecting an input 518 from the user. For example, the user interface circuitry 515 can include a display 202 adapted for producing a visually perceptible output, which may further support a touch sensitive array for receiving an input from the user. The user interface circuitry may also include a speaker 206 for producing an audio output, and a microphone 208 for receiving an audio input. The user interface output 515 could further include a vibrational element. The user interface input 518 could further include one or more user actuatable switches 204, as well as one or more cameras 210. Still further alternative and additional forms of user interface elements may be possible.

In the illustrated embodiment, the device can still further include one or more sensors 520, which can be used for gathering status information relative to the operating environment as well as the manner in which the device is being used. For example, the one or more sensors 520 can include one or more of tilt sensors 522 and/or proximity sensors 524, which the device can use to detect the usage orientation, as well as the presence of nearby elements proximate the corresponding sensors. In turn, this information can be used to help determine how other elements of the device are controlled including to which ones of the antenna elements 510 a transmit path of the transceiver 508 might be coupled.

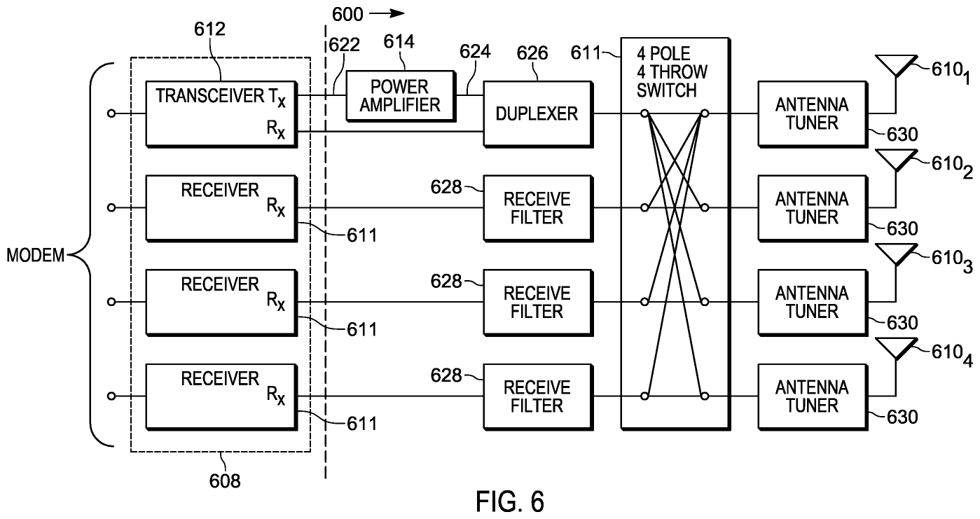

FIG. 6 illustrates a partial block diagram 600 of a radio frequency front end circuit for coupling a transceiver having a transmit path and one or more receive paths to a plurality of antennas. More specifically, the partial block diagram 600 of front end circuitry includes a power amplifier 614, which has an input 622, which is adapted for receiving a radio frequency transmit signal from a transceiver sub-element 612 of the transceiver 608, and has an output 624, which is adapted for producing an amplified radio frequency signal. The amplified radio frequency signal of the transmit path of the transceiver sub-element 612 is grouped with a corresponding receive path signal via a duplexer 626. The grouped signal is coupled to the input port of the 4-pole, 4-throw switch that can be selectively coupled to a respective one of each of the 4 output ports of the switch 611. The other three input ports of the switch are coupled to a respective receiver sub element of the transceiver 611 via a respective receive filter 628.

In turn, each of the output ports of the switch 611 is coupled to an antenna element 610 via an antenna tuner 630. In at least some instances, the antenna tuner 630 can compensate for at least some detuning of the antenna due to external factors, such as the contact and/or proximity of an external element relative to the corresponding antenna element 610 for signals having at least some frequencies, i.e. typically relatively lower radio frequency signals. Alternatively, the 4-pole, 4-throw switch 611 can be used to reroute the transmit path associated with the transmitter sub-element 612 away from antennas 610 that are deemed to be adversely affected by external factors. While an antenna is deemed to be adversely affected, the antenna can be excluded from being used with the corresponding transceiver 608 sub element having a transmit path.

In some cases, the determination of an antenna 610 being adversely affected can be determined through an analysis by the controller 502 of the readings of the one or more sensors 520. In other instances, the controller 502 can rely upon feedback signaling received from the intended destination, such as a network base station 104, to determine the extent that a particular antenna might be being affected. For example, a closed loop feedback path could be evaluated including a received signal strength indicator (RSSI) for each of the antenna elements 610 could be evaluated, and the element 610 producing the strongest signal at the intended destination could be selected. Such a check could be performed periodically to account for the possibility of changing circumstances. The output of the sensors might be monitored to control how frequently the closed loop feedback is checked.

The transceiver sub elements (receiver sub-elements 611 and transceiver sub-element 612 can each be coupled to one or more modems. The one or more modems can each be implemented as part of at least one of the one or more processors 503 of the controller 502. The controller/modem can further provide various control signaling which in turn can affect the performance of the duplexers 626 and receive filters 628, as well as the antenna tuner 630. The controller/modem can still further provide the control signal used by the 4-pole, 4-throw switch 611 to determine to which one of the antenna elements 610 the transmit path is to be currently coupled.

By taking advantage of the increase in the number of antenna elements that are included in support of enhanced signaling techniques, such as 4×4 MIMO, the instances in which a transmit path can be negatively affected by the manner in which the device is being used can be reduced. In turn this can improve transmitter functionality without necessarily resorting to increases in transmitter power, by routing transmit signal paths to antenna elements that are less likely to be experiencing current degradations in performance.

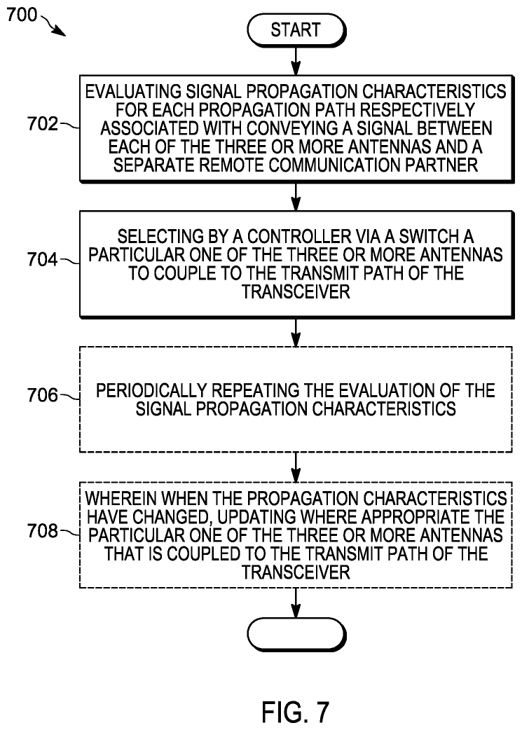

FIG. 7 illustrates a flow diagram 700 of a method for switching a transmit path of a transceiver between three or more antennas. The method 700 includes evaluating 702 signal propagation characteristics for each propagation path respectively associated with conveying a signal between each of the three or more antennas and a separate remote communication partner. A particular one of the three or more antennas is selected 704 by a controller to couple to the transmit path of the transceiver via a switch.

In some instances, the evaluation of the signal propagation characteristics are at least periodically repeated 706. When the propagation characteristics have changed, the particular one of the three or more antennas that is coupled to the transmit path of the transceiver is updated 708, where appropriate. In some instances, selecting by the controller includes a selection for coupling of the particular one of the three or more antennas, that is respectively associated with the propagation path having the smallest path losses.

While the preferred embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. An antenna switching circuit comprising:
three or more antennas;
a switch coupled to each of the three or more antennas;
a controller coupled to the switch; and
a transceiver, which is coupled to each of the three or more antennas via the switch, where each of the coupled antennas is selectively associated with a different respective receive path of the transceiver, and wherein the transceiver has a transmitter path that can be separately selectively coupled to any one of the three or more antennas via the switch under the control of the controller.

2. An antenna switching circuit in accordance with claim 1, wherein one or more of the three or more antennas can be at least temporarily excluded from being coupled to the transmitter path of the transceiver by the controller.

3. An antenna switching circuit in accordance with claim 2, wherein the antenna switching circuit further comprises one or more sensors, which can be used to detect the conditions in which one or more of the three or more antennas are at least temporarily excluded from being coupled to the transmitter path of the transceiver by the controller.

4. An antenna switching circuit in accordance with claim 3, wherein the controller monitors, on an ongoing basis, the one or more sensors, and adjusts where appropriate an exclusion by the controller of any one of the three or more antennas from being coupled to the transmitter path of the transceiver.

5. An antenna switching circuit in accordance with claim 3, wherein the one or more sensors include a tilt sensor for detecting an orientation of use of a device incorporating the antenna switching circuit.

6. An antenna switching circuit in accordance with claim 3, wherein the one or more sensors include a proximity sensor for detecting the proximity of a device incorporating the antenna switching circuit to one or more separate entities.

7. An antenna switching circuit in accordance with claim 6, wherein the proximity sensor includes one or more touch sensors.

8. An antenna switching circuit in accordance with claim 6, wherein the one or more separate entities includes a user, and the proximity sensor can detect the manner in which the user is interacting with the device incorporating the antenna switching circuit.

9. An antenna switching circuit in accordance with claim 1, wherein the switch is a multiple pole multiple throw switch.

10. An antenna switching circuit in accordance with claim 1, wherein the three or more antennas include at least four antennas in support of 4×4 multiple input and multiple output (MIMO) operation.

11. An antenna switching circuit in accordance with claim 1, where a particular one of the three or more antennas that is selectively coupled to the transmitter path of the transceiver is determined by the controller through an evaluation of signal propagation characteristics for conveying a signal between each of the three or more antennas and a separate remote communication partner.

12. An antenna switching circuit in accordance with claim 11, wherein the evaluation of the signal propagation characteristics includes an evaluation of received signal strength of a signal being conveyed by the separate remote communication partner via each of the three or more antennas.

13. An antenna switching circuit in accordance with claim 11, wherein the evaluation of the signal propagation characteristics includes closed loop feedback from the separate remote communication partner identifying a received signal strength at the separate remote communication partner of a signal originating from an entity containing the antenna switching circuit via each of the three or more antennas.

14. An antenna switching circuit in accordance with claim 11, wherein the separate remote communication partner is a base transceiver station of a cellular communication network.

15. An antenna switching circuit in accordance with claim 1, wherein the antenna switching circuit is incorporated as part of a wireless communication device.

16. An antenna switching circuit in accordance with claim 1, wherein the wireless communication device is a radio frequency cellular telephone.

17. A method for switching a transmit path of a transceiver between three or more antennas, the method comprising:
evaluating signal propagation characteristics for each propagation path respectively associated with conveying a signal between each of the three or more antennas and a separate remote communication partner; and
selecting by a controller via a switch a particular one of the three or more antennas to couple to the transmit path of the transceiver.

18. A method in accordance with claim 17, wherein selecting by the controller includes a selection for coupling of the particular one of the three or more antennas, that is respectively associated with the propagation path having the smallest path losses.

19. A method in accordance with claim 17, wherein the evaluation of the signal propagation characteristics are at least periodically repeated, and when the propagation characteristics have changed updating where appropriate the particular one of the three or more antennas that is coupled to the transmit path of the transceiver.

20. A wireless communication device comprising:
an antenna switching circuit having
three or more antennas;
a switch coupled to each of the three or more antennas;
a controller coupled to the switch; and
a transceiver, which is coupled to each of the three or more antennas via the switch, where each of the coupled antennas is selectively associated with a different respective receive path of the transceiver, and wherein the transceiver has a transmitter path that can be separately selectively coupled to any one of the three or more antennas via the switch under the control of the controller.
